(19) United States
(12) Patent Application Publication
(10) Pub. No.: US 2026/0193938 A1
(43) Pub. Date: Jul. 9, 2026

(54) WELLS HAVING NON-CIRCULAR CROSS-SECTIONS AND METHODS OF USE THEREOF

(71) Applicant: The Board of Regents of the University of Oklahoma, Norman, OK (US)

(72) Inventors: Saeed Salehi, Norman, OK (US); Catalin Teodoriu, Norman, OK (US)

(73) Assignee: The Board of Regents of the University of Oklahoma, Norman, OK (US)

(21) Appl. No.: 19/130,828

(22) PCT Filed: Nov. 21, 2023
(86) PCT No.: PCT/US2023/080805

§ 371 Date: May 16, 2025

Related U.S. Application Data
(60) Provisional application No. 63/427,134, filed on Nov. 22, 2022.

(51) Int. Cl. E21B 7/00; E21B 17/00; F24T 10/00; F24T 10/15

(52) U.S. Cl. CPC E21B 7/001; E21B 17/00; F24T 10/15; F24T 2010/50

(57) ABSTRACT

The disclosure describes a well which extends into a subterranean formation, such as a geothermal formation. The well comprises a wellbore having a portion having a first non-circular cross section, and a casing having a non-circular cross section. The casing is installed within the portion of the wellbore having a non-circular cross section. The well may be an injection well or an extraction well or both. One or more of the injection and extraction wells may be used as a system for heating a fluid and extracting the fluid as a heated fluid. The heated fluid may be used, for example, as an energy source to generate electricity.

### CROSS-REFERENCE TO RELATED APPLICATIONS

This application claims the benefit of U.S. Provisional Application No. 63/427,134, filed Nov. 22, 2022, the disclosure of which is expressly incorporated herein by reference in its entirety.

### BACKGROUND

A significant amount of renewable electric power can be provided through geothermal energy. In many geothermal power projects, a working fluid is pumped into a geothermal formation through an injection well, heated by the geothermal formation, and then withdrawn as hot working fluid from the geothermal formation through a separate extraction well. The hot working fluid can be used to generate electricity by driving steam turbines connected to electrical generators.

One of the most significant challenges in developing geothermal resources is the high drilling costs and material costs associated with these projects. A recent study comparing geothermal and oil and gas drilling found that geothermal drilling averages more than 50 days longer than drilling comparable oil and gas wells. The efficiency of mechanical rotary drilling process depends on the downhole in-situ stress, confined rock strength, rock heterogeneity, temperature, and the excavation technique. Further, the efficiency also impacted by the borehole geometry, bit type and operational parameters.

Casing and cement costs are often cited as a large capital cost for geothermal wellbores. There is, therefore, a need for an improved design for geothermal wells that addresses the costs and complications of the prior art. It is to these and other deficiencies in the prior art that present disclosure is directed

### BRIEF DESCRIPTION OF THE DRAWINGS

Several embodiments of the present disclosure are hereby illustrated in the appended drawings. It is to be noted however, that the appended drawings only illustrate several typical embodiments and are therefore not intended to be considered limiting of the scope of the inventive concepts disclosed herein. The figures are not necessarily to scale and certain features and certain views of the figures may be shown as exaggerated in scale or in schematic in the interest of clarity and conciseness.

FIG. 1 depicts a geothermal well complex constructed in accordance with a first embodiment.

FIG. 2 depicts a geothermal well complex constructed in accordance with a second embodiment.

FIG. 3 provides a cross-sectional view of a non-circular wellbore with a non-circular cross section

FIG. 4 provides a perspective view of two non-circular casing segments connected with a brazed joint.

### DETAILED DESCRIPTION

The present disclosure describes a well which extends into a subterranean formation, such as a geothermal formation. The well comprises a wellbore having a portion having a first non-circular cross section, and a casing having a non-circular cross section. The casing is installed within the portion of the wellbore having a non-circular cross section. The well may be an injection well or an extraction well or both. One or more of the injection and extraction wells may be used as a system for heating a fluid and extracting the fluid as a heated fluid. The heated fluid may be used, for example, as an energy source to generate electricity.

Additional embodiments are described in further detail below by way of exemplary description, examples, and results, however before describing such embodiments, it is to be understood that the apparatus and methods of the present disclosure are not limited in application to the details of specific embodiments and examples as set forth in the following description. The description provided herein is intended for purposes of illustration only and is not intended to be construed in a limiting sense. As such, the language used herein is intended to be given the broadest possible scope and meaning, and the embodiments and examples are meant to be exemplary, not exhaustive. Also, it is to be understood that the phraseology and terminology employed herein is for the purpose of description only and should not be regarded as limiting unless otherwise indicated as so. Moreover, in the following detailed description, numerous specific details are set forth in order to provide a more thorough understanding of the present disclosure. However, it will be apparent to a person having ordinary skill in the art that the present disclosure may be practiced without these specific details. In other instances, features which are well known to persons of ordinary skill in the art have not been described in detail to avoid unnecessary complication of the description. It is intended that all alternatives, substitutions, modifications, and equivalents apparent to those having ordinary skill in the art are included within the scope of the present disclosure. Thus, while the apparatus and methods of the present disclosure have been described in terms of particular embodiments, it will be apparent to those of skill in the art that variations may be applied to the apparatus and methods and the steps or in the sequence of steps of the methods described herein without departing from the concept, spirit, and scope of the inventive concepts.

All patents, published patent applications, and non-patent publications mentioned in the specification are indicative of the level of skill of those skilled in the art to which the present disclosure pertains. Each patent, published patent application, and non-patent publication referenced in any portion of this application is expressly incorporated herein by reference in its entirety to the same extent as if the individual patent, or published patent application, or non-patent publication was specifically and individually indicated to be incorporated by reference.

Unless otherwise defined herein, scientific and technical terms used in connection with the present disclosure shall have the meanings that are commonly understood by those having ordinary skill in the art. Further, unless otherwise required by context, singular terms shall include pluralities and plural terms shall include the singular.

As utilized in accordance with the methods and apparatus of the present disclosure, the following terms, unless otherwise indicated, shall be understood to have the following meanings. The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or when the alternatives are mutually exclusive, although the disclosure supports a definition that refers to only alternatives and “and/or.” The use of the term “at least one” will be understood to include one as well as any quantity more than one, including but not limited to, 2, 3, 4, 5, 6, 7, 8, 9, 10, 15, 20, 30, 40, 50, 100, or any integer inclusive therein. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z.

As used herein, all numerical values or ranges (e.g., in units of length such as micrometers or millimeters) include fractions of the values and integers within such ranges and fractions of the integers within such ranges unless the context clearly indicates otherwise. Thus, to illustrate, reference to a numerical range, such as 1-10 includes 1, 2, 3, 4, 5, 6, 7, 8, 9, 10, as well as 1.1, 1.2, 1.3, 1.4, 1.5, etc., and so forth. Reference to a range of 1-50 therefore includes 1, 2, 3, 4, 5, 6, 7, 8, 9, 10, 11, 12, 13, 14, 15, 16, 17, 18, 19, 20, etc., up to and including 50, as well as 1.1, 1.2, 1.3, 1.4, 1.5, etc., 2.1, 2.2, 2.3, 2.4, 2.5, etc., and so forth. Reference to a series of ranges includes ranges which combine the values of the boundaries of different ranges within the series. Thus, to illustrate reference to a series of ranges, for example, of 1-10, 10-20, 20-30, 30-40, 40-50, 50-60, 60-75, 75-100, 100-150, 150-200, 200-250, 250-300, 300-400, 400-500, 500-750, 750-1,000, includes ranges of 1-20, 10-50, 50-100, 100-500, and 500-1,000, for example. For example, a reference to a range of 1 mm to 20 mm in thickness is intended to explicitly include all units of measurement in the range.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

Throughout this application, the terms “about” or “approximately” are used to indicate that a value includes the inherent variation of error. Further, in this detailed description, each numerical value (e.g., thickness, length, temperature or time) should be read once as modified by the term “about” (unless already expressly so modified), and then read again as not so modified unless otherwise indicated in context. As noted above, any range listed or described herein is intended to include, implicitly or explicitly, any number within the range, particularly all integers, including the end points, and is to be considered as having been so stated. For example, “a range from 1 to 10” is to be read as indicating each possible number, particularly integers, along the continuum between about 1 and about 10. Thus, even if specific data points within the range, or even no data points within the range, are explicitly identified or specifically referred to, it is to be understood that any data points within the range are to be considered to have been specified, and that the inventors possessed knowledge of the entire range and the points within the range. Unless otherwise stated, the term “about” or “approximately”, where used herein when referring to a measurable value such as an amount, length, thickness, a temporal duration, and the like, is meant to encompass, for example, variations of ±20% or ±10%, or ±5%, or ±1%, or ±0.1% from the specified value, as such variations are appropriate to perform the disclosed methods and as understood by persons having ordinary skill in the art.

As used herein, the term “substantially” means that the subsequently described parameter, event, or circumstance completely occurs or that the subsequently described parameter, event, or circumstance occurs to a great extent or degree. For example, the term “substantially” means that the subsequently described parameter, event, or circumstance occurs at least 80% of the time, or at least 90%,, or at least 91%, or at least 92%, or at least 93%, or at least 94%, or at least 95%, or at least 96%, or at least 97%, or at least 98%, or at least 99%, of the time, or means that the dimension or measurement is within at least 90%, or at least 91%, or at least 92%, or at least 93%, or at least 94%, or at least 95%, or at least 96%, or at least 97%, or at least 98%, or at least 99%, of the referenced dimension or measurement (e.g., length or thickness).

The term non-circular as used herein refers to a form or cross-section that doesn't have the shape of an entire circle. The term non-circular may refer to, for example, oval, elliptical, lobed, slotted, or partially-circular shapes.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

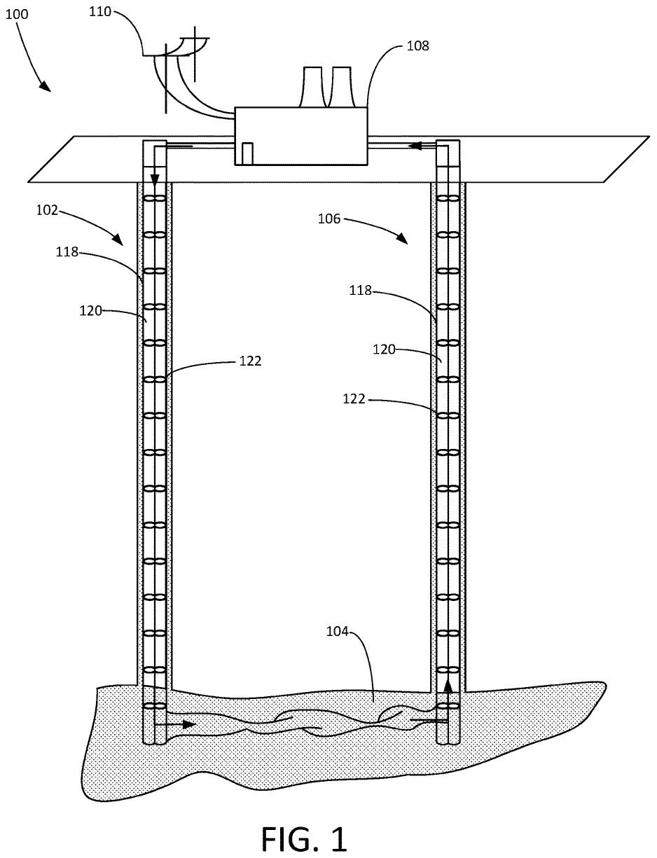

Beginning with FIG. 1, the present disclosure is generally directed at systems and methods for constructing and using a geothermal well complex 100 that overcomes many of the obstacles presented by prior art geothermal systems. In some embodiments, the geothermal well complex 100 includes one or more injection wells 102 that are configured to deliver a working fluid to a subterranean geothermal formation 104. The subterranean geothermal formation 104 includes fissures, passages or conduits that allow the working fluid to pass through the geothermal formation 104, while absorbing heat from the formation 104. In these embodiments, the geothermal well complex 100 includes one or more extraction wells 106 that are spaced apart from the injection wells 102 and configured to extract the heated working fluid from the formation 104. The extracted fluid may be in the form of a heated liquid or a heated gas, such as steam. The extraction wells 106 deliver the heated working fluid to a power plant 108 where in one embodiment the heated working fluid can be used to generate steam to drive turbines. The steam-driven turbines can be connected to electrical generators, which can produce electricity for use on a power grid 110.

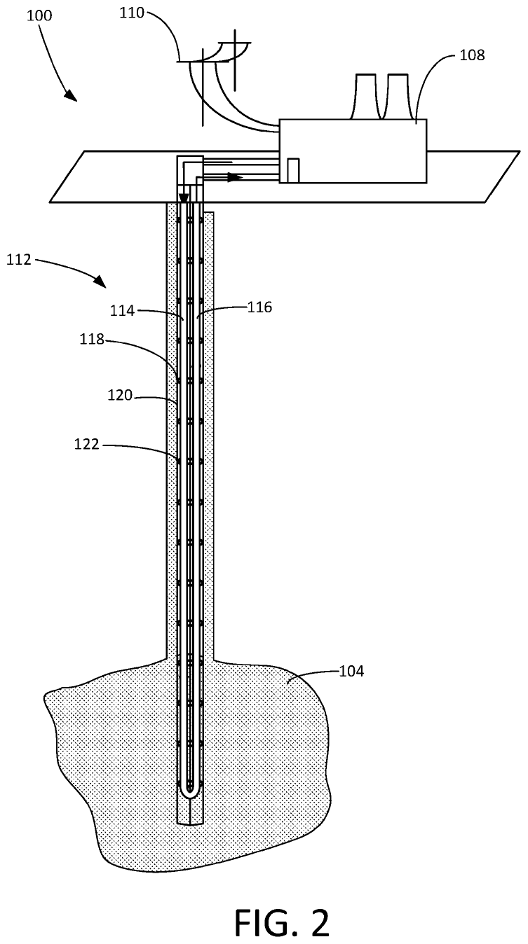

Although a single injection well 102 and a single extraction well 106 are depicted in FIG. 1, it will be understood that additional injection wells 102 and extraction wells 106 may be used within the geothermal well complex 100. In some applications, naturally occurring geothermal brine is extracted via through the extraction well 106, acts as the working fluid for power generation, and is then injected back into the ground through the injection well 102. In other embodiments, a dual-flow well 112 can be used for simultaneous injection and extraction of a working fluid. As depicted in FIG. 2, the dual-flow well 112 can include injection and extraction lines 114, 116 that carry the working fluid inside the dual-flow well 112.

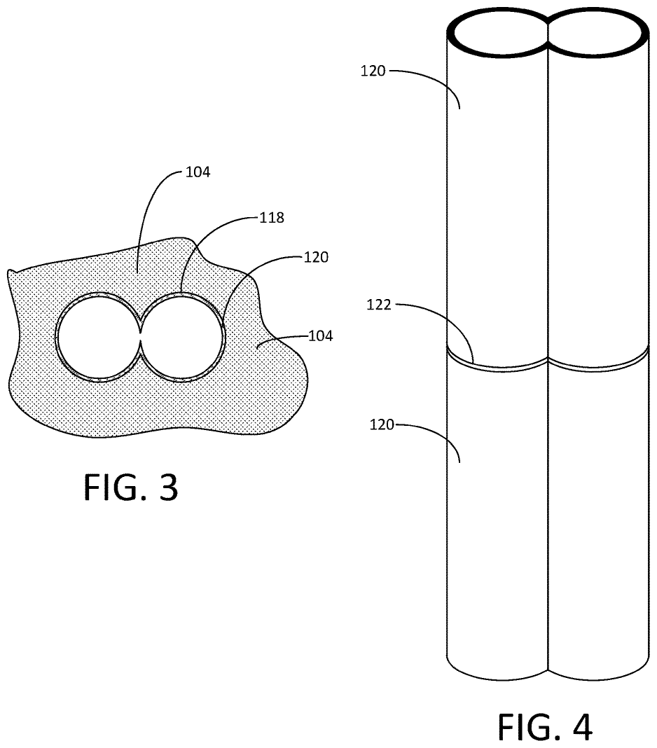

In each case, the injection well 102, the extraction well 106, and the dual-flow well 112 are configured as “monobore” wells that have wellbores 118 with non-circular cross sections, as depicted, in a non-limiting embodiment, in FIG. 3. In these embodiments, the wellbores 118 can have oval, elliptical, lobed, or slotted non-circular cross sections which can be achieved through the use of drilling systems that include multiple drill bits. A non-limiting example of a lobed wellbore, comprising an adjoined pair of partial-circular cross sections, is shown in FIG. 3. The cross-sectional shape of the wellbores 118 can change from circular to non-circular along the length of the wellbores 118 or from non-circular to circular along the length of the wellbores 118. Processes for drilling a non-circular oil and gas wellbore, and examples of wellbores with non-circular cross sections, are disclosed in United States Patent Application Publication No. 2009/0032306 A1 filed by Addis et al., the entire disclosure of which is herein incorporated by reference.

Wells with non-circular cross sections have been shown to provide improved drillability, wellbore hydraulics and hole cleaning. Additional benefits from the use of non-circular cross sections include improved in-situ maximum principal stresses in the formation, which reduces the likelihood of wellbore failures such as wellbore collapse that might otherwise occur with conventional circular wellbores. Further benefits are realized from the increased surface area of the non-circular wellbores 118, which improves heat transfer between the formation 104 and the working fluid.

The non-circular wellbores 118 can each include a non-circular casing 120 that is designed to match the cross-sectional shape of the wellbores 118. The non-circular casing 120 is configured to be installed in linearly-linked sections by lowering the non-circular casing 120 into the corresponding non-circular wellbores 118 of the injection and extraction wells 102, 106 or dual-flow well 112. In some applications, cementing processes can be used to seal the non-circular casing 120 inside the non-circular wellbore 118.

To further improve the integrity of the non-circular wellbores 118, the individual sections of the non-circular casing 120 can be connected with brazed joints 122. The use of brazed joints 122 provides a tight connection between adjacent casing segments and improves leak resistance. The brazed joints 122 allow the metallurgical joining of dissimilar materials using a filler material. In some embodiments, the brazed joints 122 are produced by using a combination of flux, filler and flame-based heat to join the adjacent casing segments together with an intermediate filler.

Therefore, the present disclosure is directed to, but not limited to, at least the particular embodiments of the following clauses.
Clause 1. At least one embodiment is a well which extends into a subterranean formation, wherein the well comprises (a) a wellbore comprising at least one portion having a first non-circular cross section, and a casing comprising a second non-circular cross section, wherein the casing is installed within the at least one portion of the wellbore having the first non-circular cross section.
Clause 2. In another embodiment, the well comprises the well of clause 1, wherein the at least one portion of the wellbore is drilled using a plurality of drill bits simultaneously to form the first non-circular cross section thereof.
Clause 3. In another embodiment, the well comprises the well of clause 1 or 2, wherein the first non-circular cross section has a first shape, and wherein the first shape is selected from the group consisting of oval, elliptical, lobed, and slotted.
Clause 4. In another embodiment, the well comprises the well of any one of clauses 1-3, wherein the second non-circular cross section has a second shape, and wherein the second shape is selected from the group consisting of oval, elliptical, lobed, and slotted.
Clause 5. In another embodiment, the well comprises the well of any one of clauses 1-4, wherein the first shape and the second shape are substantially the same.
Clause 6. In another embodiment, the well comprises the well of any one of clauses 1-5, wherein the casing comprises at least two casing segments connected by brazing.
Clause 7. In another embodiment, the well comprises the well of any one of clauses 1-6, wherein the brazing utilizes a combination of a flux, a filler and flame-based heat.
Clause 8. In another embodiment, the well comprises the well of any one of clauses 1-7, wherein the at least one portion of the wellbore has improved in-situ maximum principal stresses in the subterranean formation as compared to a wellbore having a circular cross section.
Clause 9. In another embodiment, the well comprises the well of any one of clauses 1-8, wherein the well comprises a geothermal well and the subterranean formation comprises a geothermal subterranean formation.
Clause 10. At least one embodiment is a geothermal system in a subterranean geothermal formation, comprising:
(1) at least one injection well which extends into the subterranean geothermal formation, wherein the at least one injection well comprises:
   (a) an injection wellbore comprising at least one portion having a first non-circular cross section; and
   (b) an injection casing comprising a second non-circular cross section, wherein the injection casing is installed within the at least one portion of the injection wellbore having the first non-circular cross section; and
(2) at least one extraction well which extends into the subterranean geothermal formation, wherein the at least one extraction well comprises:
   (a) an extraction wellbore comprising at least one portion having a first non-circular cross section; and
   (b) an extraction casing comprising a second non-circular cross section, wherein the extraction casing is installed within the at least one portion of the extraction wellbore having the first non-circular cross section.
Clause 11. In another embodiment, the geothermal system comprises the geothermal system of clause 10, wherein the at least one portion of the injection wellbore is drilled using a plurality of drill bits simultaneously to form the first non-circular cross section thereof, or the at least one portion of the extraction wellbore is drilled using a plurality of drill bits simultaneously to form the first non-circular cross section thereof.
Clause 12. In another embodiment, the geothermal system comprises the geothermal system of clauses 10 or 11, wherein the first non-circular cross section of the injection wellbore has a first shape, and wherein the first shape is selected from the group consisting of oval, elliptical, lobed, and slotted.
Clause 13. In another embodiment, the geothermal system comprises the geothermal system of any one of clauses 10-12, wherein the second non-circular cross section of the injection casing has a second shape, and wherein the second shape is selected from the group consisting of oval, elliptical, lobed, and slotted.
Clause 14. In another embodiment, the geothermal system comprises the geothermal system of any one of clauses 10-13, wherein the first shape of the injection wellbore and the second shape of the injection casing are substantially the same.
Clause 15. In another embodiment, the geothermal system comprises the geothermal system of any one of clauses 10-14, wherein the first non-circular cross section of the extraction wellbore has a first shape, and wherein the first shape is selected from the group consisting of oval, elliptical, lobed, and slotted.
Clause 16. In another embodiment, the geothermal system comprises the geothermal system of any one of clauses 10-15, wherein the second non-circular cross section of the extraction casing has a second shape, and wherein the second shape is selected from the group consisting of oval, elliptical, lobed, and slotted.
Clause 17. In another embodiment, the geothermal system comprises the geothermal system of any one of clauses 10-16, wherein the first shape of the extraction wellbore and the second shape of the extraction casing are substantially the same.
Clause 18. In another embodiment, the geothermal system comprises the geothermal system of any one of clauses 10-17, wherein the injection casing and/or the extraction casing comprise segments joined by brazing.
Clause 19. In another embodiment, the geothermal system comprises the geothermal system of any one of clauses 10-18, wherein the at least one portion of the injection wellbore has improved in-situ maximum principal stresses in the subterranean formation as compared to an injection wellbore having a circular cross section, or the at least one portion of the extraction wellbore has improved in-situ maximum principal stresses in the subterranean formation as compared to an extraction wellbore having a circular cross section.
Clause 20. At least one embodiment is a method of recovering geothermal heat from a subterranean geothermal formation, comprising:
(1) injecting a fluid into at least one injection well which extends into the subterranean geothermal formation, wherein the fluid is heated in the subterranean geothermal formation forming a heated fluid, and wherein the at least one injection well comprises:
   (a) an injection wellbore comprising at least one portion having a first non-circular cross section; and
   (b) an injection casing comprising a second non-circular cross section, wherein the injection casing is installed within the at least one portion of the injection wellbore having the first non-circular cross section; and
(2) extracting the heated fluid from at least one extraction well which extends into the subterranean geothermal formation, wherein the at least one extraction well comprises:
   (a) an extraction wellbore comprising at least one portion having a first non-circular cross section; and
   (b) an extraction casing comprising a second non-circular cross section, wherein the extraction casing is installed within the at least one portion of the extraction wellbore having the first non-circular cross section.
Clause 21. In another embodiment, the method comprises the method of claim 20, wherein the heated fluid comprises a heated liquid or a heated gas.
Clause 22. In another embodiment, the method comprises the method of claim 20 or 21, wherein the heated fluid to used to provide heated water or is used to generate electricity.
Clause 23. In another embodiment, the method comprises the method of any one of claims 20-22, wherein the first non-circular cross section of the injection wellbore has a first shape, and wherein the first shape is selected from the group consisting of oval, elliptical, lobed, and slotted.
Clause 24. In another embodiment, the method comprises the method of any one of claims 20-23, wherein the second non-circular cross section of the injection casing has a second shape, and wherein the second shape is selected from the group consisting of oval, elliptical, lobed, and slotted.
Clause 25. In another embodiment, the method comprises the method of any one of claims 20-24, wherein the first shape of the injection wellbore and the second shape of the injection casing are substantially the same.
Clause 26. In another embodiment, the method comprises the method of any one of claims 20-25, wherein the first non-circular cross section of the extraction wellbore has a first shape, and wherein the first shape is selected from the group consisting of oval, elliptical, lobed, and slotted.
Clause 27. In another embodiment, the method comprises the method of any one of claims 20-26, wherein the second non-circular cross section of the extraction casing has a second shape, and wherein the second shape is selected from the group consisting of oval, elliptical, lobed, and slotted.
Clause 28. In another embodiment, the method comprises the method of any one of claims 20-27, wherein the first shape of the extraction wellbore and the second shape of the extraction casing are substantially the same.
Clause 29. In another embodiment, the method comprises the method of any one of claims 20-28, wherein the injection casing and/or the extraction casing comprise segments joined by brazing.
Clause 30. In another embodiment, the method comprises the method of any one of claims 20-29, wherein the at least one portion of the injection wellbore has improved in-situ maximum principal stresses in the subterranean formation as compared to an injection wellbore having a circular cross section, or the at least one portion of the extraction wellbore has improved in-situ maximum principal stresses in the subterranean formation as compared to an extraction wellbore having a circular cross section.
Clause 31. At least one embodiment is a method of drilling a well into a subterranean formation comprising:
drilling a wellbore into the subterranean formation, wherein at least one portion of the wellbore is drilled using at least two drill bits simultaneously in the subterranean formation, wherein after the drilling is completed the at least one portion of the wellbore comprises a first non-circular cross section.
Clause 32. In another embodiment, the method comprises the method of claim 31, further comprising (1) providing a casing having a second non-circular cross section, and (2) installing the casing within the at least one portion of the wellbore comprising the first non-circular cross section.
Clause 33. In another embodiment, the method comprises the method of claim 31 or 32, wherein the casing is formed by brazing together at least two casing segments.
Clause 34. In another embodiment, the method comprises the method of any one of claims 31-33, wherein the first non-circular cross section has a first shape, and wherein the first shape is selected from the group consisting of oval, elliptical, lobed, and slotted.
Clause 35. In another embodiment, the method comprises the method of any one of claims 31-34, wherein the second non-circular cross section has a second shape, and wherein the second shape is selected from the group consisting of oval, elliptical, lobed, and slotted.
Clause 36. In another embodiment, the method comprises the method of any one of claims 31-35, wherein the first shape and the second shape are substantially the same.
Clause 37. In another embodiment, the method comprises the method of any one of claims 31-36, wherein the at least two drill bits are utilized simultaneously at substantially the same depth of the subterranean formation.
Clause 38. At least one embodiment is a well which extends into a subterranean formation, the well comprising:
(a) an injection wellbore comprising at least one portion having a first non-circular cross section, and comprising an injection casing comprising a second non-circular cross section, wherein the injection casing is installed within the at least one portion of the injection wellbore having the first non-circular cross section; and
(b) an extraction wellbore comprising at least one portion having a first non-circular cross section, and comprising an extraction casing comprising a second non-circular cross section, wherein the extraction casing is installed within the at least one portion of the extraction wellbore having the first non-circular cross section.
Clause 39. In another embodiment, the well comprises the well of clauses 38, wherein the subterranean formation in a geothermal formation, and wherein the well is a geothermal well for extracting a heated fluid from the geothermal formation.
Clause 40. In another embodiment, the well comprises the well of clause 38 or 39, wherein the at least one portion of the injection wellbore is drilled using a plurality of drill bits simultaneously to form the first non-circular cross section thereof, or the at least one portion of the extraction wellbore is drilled using a plurality of drill bits simultaneously to form the first non-circular cross section thereof.
Clause 41. In another embodiment, the well comprises the well of any one of clauses 38-40, wherein the first non-circular cross section of the injection wellbore has a first shape, and wherein the first shape is selected from the group consisting of oval, elliptical, lobed, and slotted.
Clause 42. In another embodiment, the well comprises the well of any one of clauses 38-41, wherein the second non-circular cross section of the injection casing has a second shape, and wherein the second shape is selected from the group consisting of oval, elliptical, lobed, and slotted.
Clause 43. In another embodiment, the well comprises the well of clause 42, wherein the first shape of the injection wellbore and the second shape of the injection casing are substantially the same.
Clause 44. In another embodiment, the well comprises the well of any one of clauses 38-43, wherein the first non-circular cross section of the extraction wellbore has a first shape, and wherein the first shape is selected from the group consisting of oval, elliptical, lobed, and slotted.
Clause 45. In another embodiment, the well comprises the well of any one of clauses 38-44, wherein the second non-circular cross section of the extraction casing has a second shape, and wherein the second shape is selected from the group consisting of oval, elliptical, lobed, and slotted.
Clause 46. In another embodiment, the well comprises the well of clause 45, wherein the first shape of the extraction wellbore and the second shape of the extraction casing are substantially the same.
Clause 47. In another embodiment, the well comprises the well of any one of clauses 38-46, wherein the injection casing or the extraction casing comprise segments joined by brazing.
Clause 48. In another embodiment, the well comprises the well of any one of clauses 38-47, wherein the at least one portion of the injection wellbore has improved in-situ maximum principal stresses in the subterranean formation as compared to an injection wellbore having a circular cross section, or the at least one portion of the extraction wellbore has improved in-situ maximum principal stresses in the subterranean formation as compared to an extraction wellbore having a circular cross section.

It is to be understood that even though numerous characteristics and advantages of various embodiments of the present disclosure have been set forth in the foregoing description, together with details of the structure and functions of various embodiments, this disclosure is illustrative only, and changes may be made in detail, especially in matters of structure and arrangement of parts within the principles of the present disclosure to the full extent indicated by the broad general meaning of the terms in which the appended claims are expressed. It will be appreciated by those skilled in the art that the teachings of the present disclosure can be applied to other systems without departing from the scope and spirit of the inventive concepts of the present disclosure.

1. A well which extends into a subterranean formation, the well comprising:
(a) a wellbore comprising at least one portion having a first non-circular cross section; and
(b) a casing comprising a second non-circular cross section, wherein the casing is installed within the at least one portion of the wellbore having the first non-circular cross section.

2. The well of claim 1, wherein the at least one portion of the wellbore is drilled using a plurality of drill bits simultaneously to form the first non-circular cross section thereof.

3. The well of claim 1, wherein the first non-circular cross section has a first shape, and wherein the first shape is selected from the group consisting of oval, elliptical, lobed, and slotted.

4. The well of claim 3, wherein the second non-circular cross section has a second shape, and wherein the second shape is selected from the group consisting of oval, elliptical, lobed, and slotted.

5. The well of claim 4, wherein the first shape and the second shape are substantially the same.

6. The well of claim 1, wherein the casing comprises at least two casing segments connected by brazing.

7. The well of claim 6, wherein the brazing utilizes a combination of a flux, a filler and flame-based heat.

8. The well of claim 1, wherein the at least one portion of the wellbore has improved in-situ maximum principal stresses in the subterranean formation as compared to a wellbore having a circular cross section.

9. The well of claim 1, wherein the well comprises a geothermal well and the subterranean formation comprises a geothermal subterranean formation.

10. A geothermal system in a subterranean geothermal formation, comprising:
(1) at least one injection well which extends into the subterranean geothermal formation, wherein the at least one injection well comprises:
(a) an injection wellbore comprising at least one portion having a first non-circular cross section; and
(b) an injection casing comprising a second non-circular cross section, wherein the injection casing is installed within the at least one portion of the injection wellbore having the first non-circular cross section; and
(2) at least one extraction well which extends into the subterranean geothermal formation, wherein the at least one extraction well comprises:
(a) an extraction wellbore comprising at least one portion having a first non-circular cross section; and
(b) an extraction casing comprising a second non-circular cross section, wherein the extraction casing is installed within the at least one portion of the extraction wellbore having the first non-circular cross section.

11. The geothermal system of claim 10, wherein the at least one portion of the injection wellbore is drilled using a plurality of drill bits simultaneously to form the first non-circular cross section thereof, or the at least one portion of the extraction wellbore is drilled using a plurality of drill bits simultaneously to form the first non-circular cross section thereof.

12. The geothermal system of claim 10, wherein the first non-circular cross section of the injection wellbore has a first shape, and wherein the first shape is selected from the group consisting of oval, elliptical, lobed, and slotted.

13. The geothermal system of claim 12, wherein the second non-circular cross section of the injection casing has a second shape, and wherein the second shape is selected from the group consisting of oval, elliptical, lobed, and slotted.

14. The geothermal system of claim 13, wherein the first shape of the injection wellbore and the second shape of the injection casing are substantially the same.

15. The geothermal system of claim 10, wherein the first non-circular cross section of the extraction wellbore has a first shape, and wherein the first shape is selected from the group consisting of oval, elliptical, lobed, and slotted.

16. The geothermal system of claim 15, wherein the second non-circular cross section of the extraction casing has a second shape, and wherein the second shape is selected from the group consisting of oval, elliptical, lobed, and slotted.

17. The geothermal system of claim 16, wherein the first shape of the extraction wellbore and the second shape of the extraction casing are substantially the same.

18. The geothermal system of claim 10, wherein the injection casing and/or the extraction casing comprise segments joined by brazing.

19. The geothermal system of claim 10, wherein the at least one portion of the injection wellbore has improved in-situ maximum principal stresses in the subterranean formation as compared to an injection wellbore having a circular cross section, or the at least one portion of the extraction wellbore has improved in-situ maximum principal stresses in the subterranean formation as compared to an extraction wellbore having a circular cross section.

20. A method of recovering geothermal heat from a subterranean geothermal formation, comprising:
(1) injecting a fluid into at least one injection well which extends into the subterranean geothermal formation, wherein the fluid is heated in the subterranean geothermal formation forming a heated fluid, and wherein the at least one injection well comprises:
(a) an injection wellbore comprising at least one portion having a first non-circular cross section; and
(b) an injection casing comprising a second non-circular cross section, wherein the injection casing is installed within the at least one portion of the injection wellbore having the first non-circular cross section; and
(2) extracting the heated fluid from at least one extraction well which extends into the subterranean geothermal formation, wherein the at least one extraction well comprises:
(a) an extraction wellbore comprising at least one portion having a first non-circular cross section; and
(b) an extraction casing comprising a second non-circular cross section, wherein the extraction casing is installed within the at least one portion of the extraction wellbore having the first non-circular cross section.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)
